(19) United States
(12) Patent Application Publication
(10) Pub. No.: US 2008/0141553 A1
(43) Pub. Date: Jun. 19, 2008

(54) Laundry machine and control method thereof

(75) Inventors: Chang Woo Son, Changwon-si (KR); Sang Hun Bae, Changwon-si (KR); Chul Jin Choi, Changwon-si (KR); Dong Hyun Kim, Changwon-si (KR); Young Bok Son, Changwon-si (KR); Heung Jae Kim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/980,784

(22) Filed: Oct. 31, 2007

(30) Foreign Application Priority Data
Dec. 14, 2006 (KR) 10-2006-0127588

(51) Int. Cl. F26B 11/02; D06F 58/04; F26B 21/06; G05B 11/00

(52) U.S. Cl. 34/130; 68/5 C; 34/524; 700/275

(57) ABSTRACT

The present invention relates to a laundry dryer that can prevent as well as remove wrinkles of laundry. A laundry machine includes a drum selectively rotatable, a steam generator to supply high temperature steam to the drum, and a controller to determine whether there is a malfunction of the steam generator by using a temperature increasing time inside the steam generator.

### CROSS REFERENCE TO RELATED APPLICATION

This application claims the benefit of the Korean Patent Application No. 10-2006-0127588, filed on Dec. 14, 2006, which are hereby incorporated in its entirety by reference as if fully set forth herein.

### BACKGROUND OF THE DISCLOSURE

1. Field of the Disclosure

The present invention relates to a laundry machine. More particularly, the present invention relates to a laundry machine including a steam generator, which can remove wrinkles of laundry.

2. Discussion of the Related Art

Laundry dryers are typically electric appliances that dry washed laundry, mainly washed clothes, by using high temperature air. In general, a laundry dryer is configured of a drum, a driving source, heating means and a blower unit. Laundry is held in the drum and the driving source drives the drum. The heating means heats air drawn in the drum. The blower unit sucks or discharges the air inside the drum.

Laundry dryers may be categorized, based on a method of heating air that is heating means, into electric-type laundry dryers and gas-type laundry dryers. In an electric-type laundry dryer, air is heated by using electric resistance heat. While, in a gas-type laundry dryer, air is heated by using heat generated from gas combustion. On the other hand, laundry dryers may be categorized into condensation-type laundry dryers and exhaustion-type laundry dryers. In a condensation-type laundry dryer, air is heat-exchanged with laundry in the drum and the damp air is circulated, not discharged outside, to be heat-exchanged with external air at an auxiliary condenser. At this time, water is condensed and discharged outside. In an exhaustion-type laundry dryer, air is heat-exchanged with laundry in the drum and the damp air is directly discharged outside the laundry dryer. Also, laundry dryers may be categorized, based on a method of loading laundry, into top loading-type laundry dryers and front loading-type laundry dryers. In a top loading-type laundry dryer, laundry is loaded into the drum through a top of the laundry dryer. In a front loading-type laundry dryer, laundry is loaded into the drum through a front of the laundry dryer.

However, above conventional laundry dryers may have following problems.

Commonly, the laundry having performed washing and spinning is loaded and dried in the conventional laundry dryers. In a view of a principle of water washing, washed laundry has wrinkles and the wrinkles created during the washing and spinning are not removed during the drying. As a result, auxiliary ironing is necessary in the conventional laundry dryer to remove the wrinkles, which causes a problem.

Moreover, in case that clothes rather than the washed laundry are kept and used, the clothes like the washed laundry may have wrinkles, crumples and fold marks (hereinafter, referenced to as ‘wrinkles’). Accordingly, there have been demands for development of devices capable of removing wrinkles easily even after common usage and keeping.

### SUMMARY OF THE DISCLOSURE

Accordingly, the present invention is directed to a laundry dryer.

An object of the present invention is to provide a laundry machine that can remove wrinkles of laundry.

Another object of the present invention is to provide a laundry machine that has a safety unit to protect a system determining whether there is a malfunction of a steam generator.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a laundry machine includes a drum selectively rotatable; a steam generator to supply high temperature steam to the drum; and a controller to determine whether there is a malfunction of the steam generator by using a temperature increasing time inside the steam generator.

In another aspect of the present invention, a control method of a laundry machine comprising a steam generator including a water tank to hold water and a heater to heat the water inside the water tank, the control method includes a first step to count a temperature increasing time in the steam generator heated by the heater; and a second step to determine whether there is a malfunction of the steam generator based on the counted temperature increasing time.

During the steam generation, it is determined whether there is a malfunction of the steam generator by using the temperature increasing time in the steam generator.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

In the drawings:

FIG. 1 is a an exploded perspective view illustrating an embodiment of a laundry dryer according to the present invention;

FIG. 2 is a longitudinally sectional view of FIG. 1;

FIG. 3 is a sectional view illustrating a steam generator shown in FIG. 1; and

FIG. 4 is a diagram illustrating a laundry machine to determined whether there is a malfunction of a steam generator; and

FIG. 5 is a flow chart of a control method of the laundry machine to determine whether there is a malfunction of the steam generator.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

To explain a laundry dryer according to the present invention, a top loading-type, electric-type and exhaustion-type laundry dryer will be presented as examples on convenience sake. However, the present invention is not limited to the above examples and it can be applicable to a front loading-type, gas-type and condensation-type laundry dryer. In addition, a laundry machine which will be descried as follows will be a laundry dryer. However, the laundry machine to which the present invention is applied is not limited to a laundry dryer, and may be a laundry washer and laundry washer having a drying function.

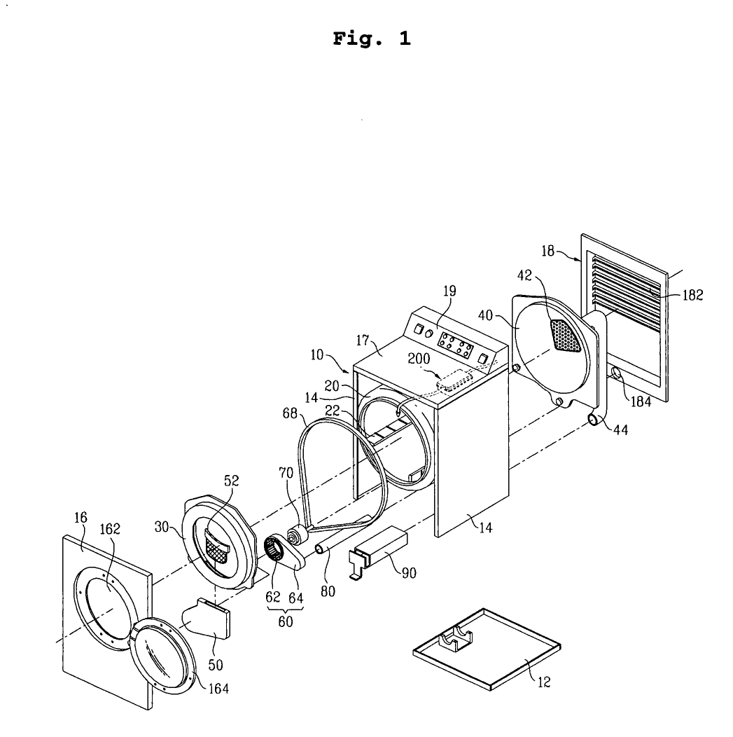

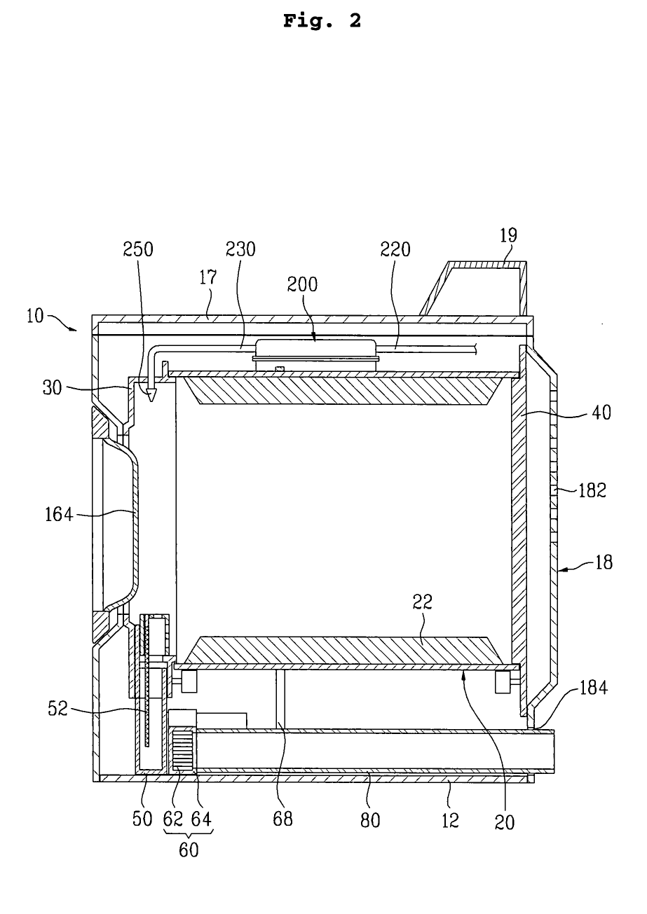

In reference to FIGS. 1 and 2, an embodiment of the laundry dryer according to the present invention will be explained.

A cabinet 10 defines an exterior appearance of the laundry dryer and a drum 20 is rotatable in the cabinet 10. A motor 70 and a belt 68 drive the drum 20. A hot air heater 90 is provided in a predetermined portion of the cabinet 10 to heat air and to create high temperature air (hereinafter, hot air). A hot air supply duct 44 is provided in a predetermined portion of the cabinet 10 to supply the hot air of the hot air heater 90 to the drum 20. Also, there are provided an exhaustion duct 80, a blower unit 60 in the laundry dryer according to the present invention. The damp air heat-exchanged with the laundry in the drum 20 is discharged outside the drum 20 through the exhaustion duct 80 and the blower unit 60 sucks the damp air. A steam generator 200 is provided in a predetermined portion of the cabinet 10 to generate high temperature steam. This embodiment presents on convenience sake an indirect drive type in that the drum 20 is rotated by the motor 700 and the belt 68 and the present invention is not limited thereto. That is, it is possible to apply to the present invention a direct drive type in that the drum 20 is directly rotated by connecting the motor 70 to a rear surface of the drum 20.

Each configuration will be explained in detail.

The cabinet 10 defines an exterior appearance of the laundry dryer and it includes a base 12, a pair of side covers 14, a front cover 16, a rear cover 18 and a top cover 17. The base 12 forms a bottom surface of the laundry dryer and the side covers 14 are perpendicular to the base 12. The front cover 16 and the rear cover 18 are installed in a front portion and a rear portion of the side covers 14, respectively. The tope cover 17 is installed in an upper portion of the side covers 14. A control panel 19 having various operational switches is positioned at the top cover 17 or the front cover 16 and the door 164 is coupled to the front cover 16. An air inlet 182 and an air outlet 184 are provided at the rear cover 18. External air is drawn through the air inlet 182 and the air inside the drum 20 is discharged outside through the air outlet 184 that is a final path to an outside.

An inner space of the drum 20 is employed as a drying chamber for drying the laundry. It is preferable that a lifter 22 is installed in the drum 20 to lift and drop the laundry, such that the laundry is turned over to enhance drying efficiency.

On the other hand, a front supporter 30 is provided between the drum 20 and the cabinet 10, in other words, between the drum 20 and the front cover 16. A rear supporter 40 is provided between the drum 20 and the rear cover 18. The drum 20 is rotatable between the front supporter 30 and the rear supporter 40, and sealing members (not shown) for preventing water leakage are coupled between the front supporter 30 and the drum 20 and between the drum 20 and the rear supporter 40, respectively. The front supporter 30 and the rear supporter 40 of the drum 20 close a front and a rear surface, respectively, to support a front and rear end of the drum 20 as well as to form the drying chamber.

An opening is formed at the front supporter 30 to communicate the drum 20 with an outside and the opening is selectively opened and closed by the door 164. In addition, a lint duct 50 as a path through which the air in the drum 20 flows outside is connected to the front supporter 30 and a lint filter 52 is installed at the lint duct 50. A predetermined portion of the blower unit 60 is connected to the lint duct 50 and the other opposite predetermined portion of the blower unit 60 is connected to the exhaustion duct 80. Here, the exhaustion duct 80 is in communication with the air outlet 184 provided at the rear cover 18. As a result, once the blower unit 60 is operated, the air inside the drum 20 flows through the lint duct 50, the exhaustion duct 80 and the air outlet 184 in order, only to be exhausted outside. At this time, foreign substances including lint are filtered by the lint filter 52. Commonly, the blower unit 60 is configured of a blower 62 and a blower housing 64. The blower 64 is commonly connected to the motor 70 for driving the drum 20.

An opening 42 formed of plural through-holes is formed at the rear supporter 40 and the hot air supply duct 44 is connected to the opening 42. The hot air supply duct 44 is in communication with the drum 20 and it is employed as a path for supplying hot air to the drum 20. For that, the hot air heater 90 is mounted in a predetermined portion of the hot air supply duct 44.

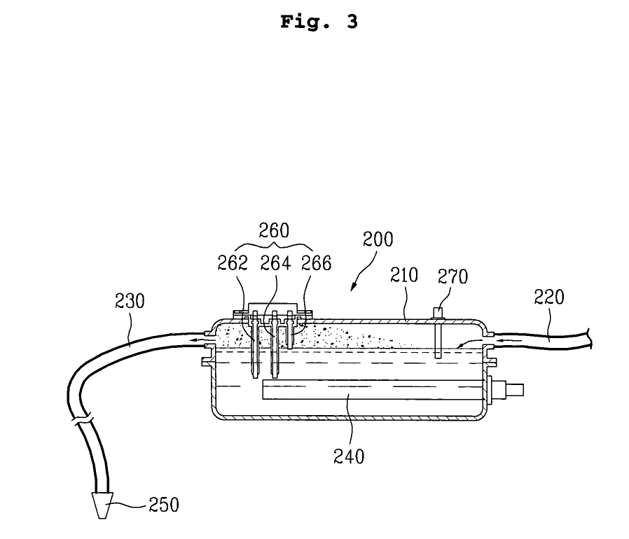

On the other hand, the steam generator 200 is provided in a predetermined portion of the cabinet 10 to generate steam and the generated steam is supplied to the drum 20. In reference to FIG. 3, the steam generator 200 will be explained in detail.

The steam generator 200 is configured of a tank 210, a heater 240, a water level sensor 260 and a temperature sensor 270. Water is held in the tank 210 and the heater 240 is mounted in the tank 210. The water level sensor 260 senses water levels in the steam generator 200 and the temperature sensor 270 senses temperatures in the steam generator 200. The water level sensor 260 is configured of a common electrode 262, a low water level electrode 264 and a high water level electrode 266. A high water level is sensed based on whether an electric current is applied between the common electrode 262 and the high water level electrode 266, and a low water level is sensed based on whether an electrode current is applied between the common electrode 262 and the low water level electrode 264.

A water supply hose 220 is connected to a predetermined portion of the steam generator 200 and a steam hose 230 is connected to the other opposite predetermined portion of the steam generator 200. Here, it is preferable that a nozzle 250 having a predetermined shape is provided at a front end of the steam hose 230. An end of the water supply hose 220 is typically connected to an external water supply source such as a water tap. The nozzle 250, that is, a steam outlet is positioned at a predetermined portion in the drum 20 to spray steam in the drum 20.

In the meantime, this embodiment presents a kind of the steam generator 200 in that the heater 240 heats the water in the tank 210 to generate steam (called as “tank heating type steam generator” on convenience sake) and the present invention is not limited thereto. That is, any devices capable of generating steam may be applicable to the present invention. For example, a kind of a steam generator in that a heater is directly installed around a water supply hose to heat the water in the water supply hose, without storing water in a predetermined space, (called as “a pipe heating type steam generator”) may be applicable to the present invention.

The process of supplying steam in the dryer according to this embodiment will be described.

In the steam supply process, steam is supplied to the drum to perform functions of removing wrinkles of laundry or sterilizing laundry. The steam is supplied for a predetermined time period (T_steam). At this time, it is preferable that the drum is tumbling, especially, that the drum is tumbling intermittently. The steam supply time (T_{—steam}) may be preset by experiments performed based on elements such as the amount of laundry.

As a water level inside the steam generator is lowered during the steam supply process, it is preferable that water is supplied to the steam generator if a predetermined low water level is sensed. In this case, water may be supplied continuously until a predetermined high water level is sensed and it is preferable that water is supplied for a predetermined time period before the high water level is sensed, for example, for 3 seconds.

As the heater 240 provided in the steam generator 200 is commonly in contact with the water held in the water tank 210, sediment including calcium compounds contained in the laundry may accumulate on a surface of the heater 240. Such calcium compound sediment might result in deterioration of heater efficiency.

Especially, heat radiation of the heater 240 may accelerate a calcium compound sediment phenomenon in Europe where soft water is used. To solve that, the present invention presents that an inside temperature of the steam generator 200 is continuously sensed by a temperature sensor 270 to determine whether there is a malfunction of the steam generator 200.

Here, a time taken for the inside temperature of the steam generator 200 to reach a predetermined valve is counted to determine whether there is a malfunction of the steam generator 200. If the heater 240 is not heated normally, the inside temperature of the steam generator 200 may not increase. Thus, whether there is a malfunction of the steam generator 200 is determined by using the time taken for the inside temperature to increase.

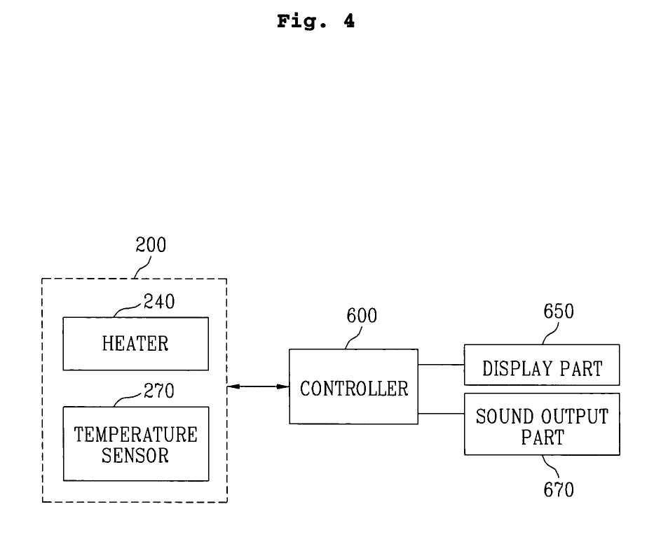

As shown in FIG. 4, the dryer according to the present invention includes a steam generator 200 that supplies hot steam to the drum and a controller 600 that determines whether there is a malfunction of the steam generator 200 by counting the time for the temperature inside the steam generator 200 to increase.

Here, the controller 600 reads from the temperature sensor 270 an inside temperature of a water tank 210 heated by the heater 240. The controller 600 counts the time taken for the inside temperature of the water tank 210 to reach a predetermined value to determine whether there is a malfunction of the heater 240.

The dryer according to the present invention further includes a display part 650 and a sound output part 670. If the malfunction of the steam generator 200 is sensed under the control of the controller 600, the display part 650 displays the malfunction to a user. The sound output part 670 outputs an abnormal state by using a voice or buzzer.

The steam generator malfunction sensing process and a method of taking predetermined steps when a malfunction is sensed will be explained.

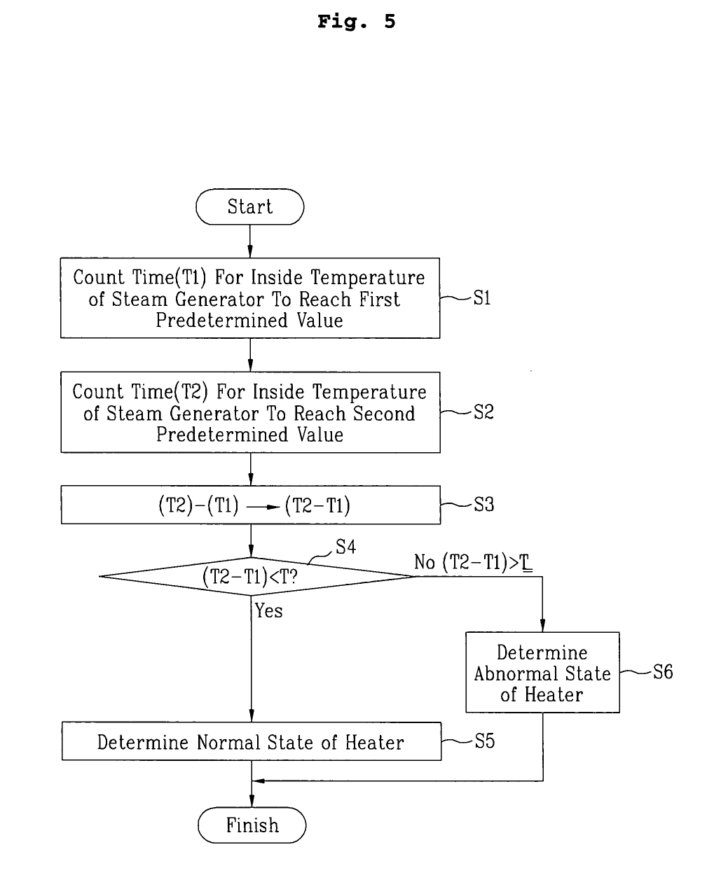

As shown in FIG. 5, once an operation of the steam generator 200 starts, the heater 240 radiates heat and water inside the water tank 210 is heated.

At this time, the inside temperature of the water tank 210 heated by the heater 240 is continuously read by the controller 600. A first taken time T1 is counted and memorized (S1) and the first taken time T1 is the time taken for the inside temperature of the water tank 210 to reach a first predetermined temperature value (50° C.).

Hence, a second taken time T2 is counted and memorized as the heater 240 radiates heat continuously (S2). The second taken time is the time taken for the inside temperature of the water tank 210 to reach a second predetermined value (90° C.).

The temperature increasing time taken to reach the second predetermined value from the first predetermined value is calculated by subtracting the first taken time T1 from the second taken time T2 (T2−T1) when the inside temperature of the water tank 210 reaches the second predetermined value (S3).

Here, the first predetermined value of temperature may be preset at 20° C. and the second predetermined value may be preset at the boiling point, 100° C.

However, it is preferable that the first predetermined value of the inside temperature is preset over room temperature, as considering a possibility that the inside temperature of the water tank 210 has been already heated over 20° C. in an repeated operation of the steam generator 200. In addition, it is preferable that the second predetermined value is preset below the boiling point.

In another method of calculating the temperature increasing time (T2−T1), the temperature increasing time is counted from a time when the inside temperature of the water tank 210 reaches the first predetermined value, and the time continuously counted for the inside temperature to reach the second predetermined value is recognized as the temperature increasing time (t2−T1).

That is, whether there is a malfunction of the heater 240 is determined by using the temperature increasing time (T2−T1). For example, if there is a malfunction of the heater 240 that the heater 240 does not work or gives off insufficient heat, the water inside the water tank 210 is not heated or slowly heated. As a result, the temperature increasing time (T2−T1) is larger(or longer) than a predetermined time.

The predetermined time varies with an output capacity or a power supply of the heater 240. The predetermined time may be determined through repeated experiments under identical environments.

If the temperature increasing time (T2−T1) is equal to or less than the predetermined time, that is, the inside temperature of the water tank 210 increases from the first predetermined value to the second predetermined value in the predetermined time period, it is determined that the heater 240 is in a normal state (S4, S5).

If the temperature increasing time (T2−T1) is over the predetermined time, it is determined that the heater 240 is in an abnormal state (S4, S6).

If it is determined that the heater 240 is in an abnormal state, the operation of the steam generator 200 is stopped and the display part 650 may display an error message indicating a malfunction of the heater.

Also, the sound output part 670 outputs a warning voice message or a buzzer to warn a malfunction of the heater to a user, together with the stop of the steam generator 200.

That is, the malfunction of the heater 240 sensed during the operation of the steam generator 200 and the corresponding operational stop of the steam generator 200 are warned to a user by the display part 650 or the sound output part 670.

As a result, the laundry machine according to the present invention may be applicable to a washer or dryer having the steam generator 200 and the efficiency of the heater 240 may be determined by the temperature increasing time inside the steam generator 200.

To protect the system at the moment when a malfunction of the heater 240 is sensed, the operation of the steam generator 200 is forcibly stopped and the abnormal state of the product is warned to a user.

Therefore, the laundry machine and the control method thereof according to the present invention may have following advantageous effects.

First, the laundry machine according to the present invention has an advantageous effect that wrinkle removal and sterilization of the laundry can be performed efficiently.

Furthermore, according to the present invention, it is sensed whether there is a malfunction of the steam generator by checking the temperature increasing time inside the steam generator continuously. As a result, safe products can be presented.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A laundry machine comprising:
a drum selectively rotatable;
a steam generator to generate to steam to supply to the drum; and
a controller to sense a malfunction of the steam generator by using a temperature increasing time of the steam generator.

2. The laundry machine of claim 1, wherein the steam generator comprises,
a water tank to hold water:
a heater to heat the water in the water tank; and
a temperature sensor to sense an inside temperature of the water tank.

3. The laundry machine of claim 2, wherein the controller calculates the temperature increasing time with a counted time until an inside temperature of the water tank reaches a predetermined.

4. The laundry machine of claim 1, further comprising an indicator to indicate malfunction to a user if there is a malfunction of the steam generator.

5. The laundry machine of claim 4, wherein the indicator comprises a display to display a message for the malfunction or a speaker to output a sound to indicate the malfunction to the user.

6. A control method of a laundry machine comprising a steam generator including a water tank to hold water and a heater to heat the water inside the water tank, the control method comprising:
counting a temperature increasing time of the steam generator; and
sensing a malfunction of the steam generator based on the counted temperature increasing time.

7. The control method of claim 6, wherein, the counting comprises counting time until an inside temperature of the steam generator to reach a second predetermined value (T2) from a first predetermined value (T1).

8. The control method of claim 7, wherein the sensing comprises sensing that the heater is in a normal state if the temperature increasing time (T2−T1) is less than a predetermined time; and
the heater is in an abnormal state if the temperature increasing time (T2−T1) is over the predetermined time.

9. The control method of claim 8, further comprising:
indicating to a user that the heater is in an abnormal state.

10. The control method of claim 9, wherein the indicating comprises displaying an error message or outputing a voice or buzzer if the heater is in an abnormal state.

11. The control method of claim 8, further comprising:
turning off the steam generator if the heater is in an abnormal state.
